(19) United States
(12) Patent Application Publication
(10) Pub. No.: US 2001/0038225 A1
(43) Pub. Date: Nov. 8, 2001

(54) Hard truck bed cover

(76) Inventor: Scott Arthur William Muirhead, Uniontown, PA (US)

Correspondence Address: SCOTT MUIRHEAD, 2269 150TH ST, SURREY, BC, V4A 9X1, CA

(21) Appl. No.: 09/785,835

(22) Filed: Feb. 20, 2001

Related U.S. Application Data
(60) Provisional application No. 60/185,852, filed on Feb. 29, 2000.

(51) Int. Cl. B60P 7/02

(52) U.S. Cl. 296/100.06; 296/100.1

(57) ABSTRACT

A hard cover assembly for the open bed of a pickup truck is provided comprising a rigid cover and a rail kit. A rigid cover, with a crowned central body portion, constructed out of thermoplastic having a relatively high coefficient of linear thermal movement is used for operation within an outdoor environment having a wide range of temperature variation. A rail kit comprising molded thermoplastic members configured to closely conform to and protect the truck bed rails is combined with the rigid cover to provide a complete hard cover assembly. The molded thermoplastic members of the rail kit include a channel receiving a depending perimeter lip of the rigid cover. The channel is developed to accommodate the linear thermal movement of the rigid cover and may be further adapted to limit the full linear thermal expansion of the rigid cover thereby causing the crowned central body portion to deflect upwards. A lock assembly is provided to lock the rigid cover in a closed position under the full range of temperature variation. The hard cover assembly is installed onto the bed rails by means of hand adjustable fasteners. In particular, the rail kit is mounted directly to the bed rails by a plurality of hand clamps that can be inspected and adjusted by the vehicle owner to ensure safe operation. The rigid cover is hinge mounted to the rail kit using hand knobs so that the vehicle owner can conveniently install and remove the rigid cover for different cargo carrying needs.

The present application claims priority under 35 U.S.C § 119(e) based on U.S. Provisional Application No. 60/185,852 filed Feb. 29, 2000.

### FIELD OF THE INVENTION

This invention is generally directed toward a top for a land vehicle. More particularly, this invention is directed to a hard cover for a pickup truck cargo bed.

### BACKGROUND OF THE INVENTION

Pickup truck vehicles are used for both work-related activities and personal transportation. The pickup truck bed provides carrying space for both work-related and personal cargo. In order to prevent cargo carried inside the truck bed from being damaged by weather or stolen by thieves, it has become common to install a protective cover over the truck bed.

One particularly successful type of cover is referred to as a tonneau cover. There are three categories of tonneau cover in use. These include hard covers, soft covers, and retractable, folding or “specialty” covers. A large number of prior art devices including all three categories have been proposed, and are disclosed under U.S. Patent Classification 296/100. Many advancements in the soft and “specialty” cover categories have been translated in one way or another to hard cover devises. Therefore, advancements in soft covers can be referenced by U.S. Pat. No. 4,838,602 to Nett, U.S. Pat. No. 4,941,705 to Wurtz, U.S. Pat. No. 5,058,652 to Wheatley et al, U.S. Pat. No. 5,186,514 to Ronai, U.S. Pat. No. 5,480,206 to Hathaway et al, U.S. Pat. No. 5,553,652 to Rushford, U.S. Pat. No. 5,655,808 to Wheatley, U.S. Pat. No. 5,984,400 to Miller et al., U.S. Pat. Nos. 6,024,401 and 6,024,402 both to Wheatley. Advancements in “Specialty” covers, including retractable, folding and multi-part covers can be referenced by U.S. Pat. No. 4,479,677 to Gulette et al., U.S. Pat. No. 4,550,945 to Englehardt, U.S. Pat. No. 4,776,629 to Cross, U.S. Pat. No. 4,832,394 to Macomber, U.S. Pat. No. 4,861,092 to Bogard, U.S. Pat. No. 5,636,893 to Wheatley et al., U.S. Pat. No. 4,946,217 to Steffen et al., and U.S. Pat. Nos. 5,931,521 and 6,000,744 both to Kooiker.

The hard cover category of product is very popular, and represents the largest dollar volume in annual sales for cover manufacturers. Within this category of product, the most popular hard covers by a wide margin are the rigid fiberglass tonneau covers of a unitary construction. Hard covers that are not rigid fiberglass tonneau covers will be known by referring to U.S. Pat. No. 4,273,377 to Alexander, U.S. Pat. No. 4,762,360 to Huber, U.S. Pat. No. 5,743,586 to Nett and U.S. Pat. No. 5,795,011 to Flentge.

The Truck Cap & Accessory Association (TCM) compiles statistics on rigid fiberglass tonneau cover product sales. A group of twenty-seven (27) rigid fiberglass tonneau cover manufacturing companies participate in a TCAA product sales reporting program. This group of manufacturers report sales of approximately 220,000 units into the North American market each year. A prior art devise that is representative of the product sales referenced by TCM is exemplified by U.S. Pat. No. 5,688,017 to Bennett.

As known by those familiar with rigid fiberglass tonneau covers, the art of a lay-up construction of thermosetting resins and glass fiber reinforcement is well understood and has been practiced virtually unchanged for generations. With the exception of the cited reference U.S. Pat. No. 4,824,162 to Geisler et al, it is a strait forward matter to produce fiberglass shells adapted to cover land vehicles.

The mechanical apparatus of rigid fiberglass tonneau covers has advanced since the earliest prior art patents and devises of the 1940s. However, there are three essential mechanical systems interfacing with a fiberglass cover shell and a pickup truck bed. These include a hinge assembly to open and close the cover for access to cargo; a lock to secure the cover in a closed position; and, a counter balance to support the cover in operative open positions. A fourth rail support assembly has been added in recent years to help interface a rigid heavyweight fiberglass shell to the pickup truck vehicle. An example of such a rail support assembly may be known by referring to U.S. Pat. Nos. 4,079,989 and 5,688,017. In effect, the rail support prevents the rigid fiberglass shell from damaging the metal bed rail surfaces of pickup truck.

Thus, it may be appreciated that a large number of practitioners of the fiberglass method offer essentially a commodity product. Differentiation among products offered within the market is achieved through relative execution of the fiberglass construction, and the now four mechanical systems used to produce rigid fiberglass tonneau covers. The art is well known, and numerous distinguishing factors determine the relative desirability of one product over a second product.

A new style of hard tonneau cover has been disclosed by the present inventor in U.S. patent application Ser. No. 09/571,043 filed May 15, 2000, and is herein incorporated in its entirety by such reference. A hard cover composed of two sheets of heat deformable plastic material fused together to produce a unitary construction is disclosed. Thermoformed hard covers have been proposed in the past, but have been difficult to implement, and successful thermoformed hard covers are therefore unknown in the industry. Examples of proposed thermoformed hard covers may be known by referencing U.S. Pat. No. 3,762,762 to Beveridge et al., and U.S. Pat. No. 3,785,698 to Dean et al. The thermoformed hard cover of the referenced patent application has been advanced, in part, to overcome the problems of translating the solutions fiberglass methodologists have used in the past to provide hinges, locks, counterbalances and support frames for thermoformed hard covers of the earlier art.

Rigid fiberglass tonneau covers are installed onto the truck bed by one of two methods. In the earliest method, fiberglass hard cover installation hardware attaches into the metal structure of the truck bed by means of a plurality of sheet metal screws or other substantially similar fastening devises. The problem with this approach is that the sheet metal forming the truck bed is modified, which reduces the resale value of the vehicle. The first method is now largely a thing of the past. In the second method, the rigid fiberglass cover is attached to a frame assembly, and the frame assembly is attached onto the truck bed. As disclosed by Penner in U.S. Pat. No. 2,989,340, sheet metal fasteners are offered to attach the frame sub-assembly to the truck bed. Early frame devises were advantageous because they deflected/absorbed damaging stress away from the truck bed rails. These systems were later adapted for relatively convenient removal from the truck bed, as in Penner, U.S. Pat. No. 4,124,247. Other attachment methods, as for example U.S. Pat. No. 4,079,989 to Roberston and U.S. Pat. No. 5,228,736 to Dutton, were advanced to eliminate sheet metal deforming fasteners. The frame support method was later advanced further when tool adjusted clamps replaced fasteners. Tool operated clamps have now become the standard mounting methodology in the industry. The frame support was advanced yet again, with a number of different approaches that reduced damage to the truck bed, and facilitated relatively convenient removal, as characterized in FIG. 4 of U.S. Pat. No. 5,860,691 to Thomsen et al. Clamp on frames provide a “no drill” solution, the sheet metal forming the truck bed therefore remains unmodified, and the resale value of the vehicle is thus preserved.

Accordingly, a number of options are known to those skilled in the fiberglass methodologies to provide means for hinging, balancing, locking and preventing sheet metal damage. In implementing a thermoformed hard cover, the present inventor has learned that the apparent options common to fiberglass hard covers are impractical or not sufficiently advanced to translate from fiberglass construction experience to a thermoformed construction for a hard tonneau cover.

A problem related to hinge assemblies characteristic of the fiberglass methodology is that the hinge elements attaching to the fiberglass shell are inoperable in a thermoformed plastic shell. Fiberglass materials provide greater localized strength than thermoformed plastic. As shown in U.S. Pat. No. 4,324,429 to Wilson et al., a relatively small hinge element may be securely fastened to fiberglass with a plurality of fasteners with good results. The art of the fiberglass methodology teaches that the focused pressure points may also be reinforced with inserts that absorb hinging stress, such as aluminum plates. A hinge leaf fastening arrangement, as in Goble U.S. Pat. No. 5,340,188 would however distress the thermoformed hard cover to fatigue. Fiberglass hinging methodologies can not be translated to thermoformed plastic, because hinge apparatus stress must be distributed over a comparatively large area of the thermoformed hard cover. The hinge apparatus shown in U.S. Pat. No. 5,632,522 to Gaitan et al. may be adapted for thermoformed hard covers, and to some advantage, but the additional hardware cost of this method is unnecessary when the thermoformed hard cover is appreciated. The problems corrected by the hinge and lift system of Lunney in U.S. Pat. No. 5,971,446 have been solved in the present invention with less sophisticated and expensive apparatus. A different and low cost approach is needed to accomplish hinging action in a thermoformed hard cover.

A problem with the lock methodology of rigid fiberglass tonneau covers is that a substantially fixed position is used to locate the receiving end of the lock assembly that is attached to the vehicle. This approach is inoperable with thermoformed hard covers because thermoformed plastic materials have a coefficient of thermal movement that is considerably greater than fiberglass. If the operating environment of a full size truck bed hard cover is −40° to +160° F., the rate of thermal movement of a thermoformed cover is greater than +/−0.5 inches from a starting temperature of 60° F. (in/in/° F. ˜4.0−6.0 E−0.05). Therefore a fixed lock-receiving end, such as a rotary lock, is not a satisfactory approach for thermoformed hard covers. A fixed point receiving end lock can be referenced in U.S. Pat. No. 5,688,017 to Bennett.

The counter balancing methodologies used in rigid fiberglass covers is also problematic. In reference to the patent pending devise of the present inventor, it has already been disclosed that counter balancing apparatus must produce a constant closing force when the thermoformed cover is closed. The constant thrusting force of the counter balance must be directed in a manner operable to close the cover rather than open the cover. Thermoformed hard covers have less high temperature strength than fiberglass covers. Therefore, the lift systems of Penner U.S. Pat. No. 4,124,247 and Wislon et al U.S. Pat. No. 4,324,429 would strain a thermoformed hard cover. The localized counter balance pressure points associated with fiberglass methodologies must also be widely distributed over a wide area to preserve the predetermined shape and desired appearance of a thermoformed hard cover. The lift system proposed by Miller in U.S. Pat. No. 5,503,450 could be developed more readily to thermoformed hard covers, but the additional associated hardware cost is unnecessary when a thermoformed hard cover is appreciated. The lift system of Nesbeth in U.S. Pat. No. 5,909,921 is impractical for the present invention. The lift system of Buchanan in U.S. Pat. No. 5,944,376 could be adapted to the present invention provided the lifting force is distributed through a wide area of the thermoformed hard cover. The lift system of Lund et al. U.S. Pat. No. 5,988,728, could likewise be more readily translated for advantage to a thermoformed hard cover. However, the Lund methodology does not compliment the present invention which is preferred for providing a hard cover that is simple to partially or completely remove and reinstall upon the truck bed.

Rigid fiberglass tonneau covers are considerably heavier than comparably sized thermoformed hard covers. The specific weight of fiberglass is approximately 35% greater than the thermoformable plastic materials that may be economically used to construct a hard cover. Therefore, another problem is that hand tools are required to clamp the installation hardware of the heavy weight rigid tonneau cover to the pickup truck vehicle. In particular, clamps with threaded elements and bolts are tightened with a wrench or hand tool to hold the frame assembly upon the truck bed. These arrangements sometimes lead to damage, including deformation or abrasion of the metal surfaces of the truck bed rails. The lighter weight construction of a thermoformed hard cover requires less clamping force (and less lifting force) for implementation and is therefor more amenable to less destructive and other tool operated clamping methodologies.

As pickup truck vehicles are used for a variety of purposes, it is often desirable to remove an installed hard cover for an open truck bed. The two common methods of rigid fiberglass tonneau cover attachment present problems when a vehicle operator wants to remove the hard cover from the truck bed. In the case of derivatives of the first method of installation, it may be necessary to remove some of the fasteners from the sheet metal forming the truck bed. This requirement increases the damage to the sheet metal each time the hardware is removed and reinstalled onto the truck bed. (Fasteners joining rail support members are also problematic.) In the case of the second method of installation, the clamps have to be disengaged so that the hard cover and the cooperative frame assembly can be removed from the truck bed. The rigid fiberglass cover arrangement requires hand tools to disengage the clamps and the lifting efforts of two or more people to remove a comparatively heavy weight fiberglass cover and its associated frame assembly from the truck bed. In both cases, both methods of attachment present the vehicle operator with a number of problems that make it inconvenient to use an open truck bed and return to a closed truck bed when desired. In U.S. Pat. No. 5,688,017, Bennett proposes a rail that maintains a low profile, and a fiberglass cover that is removed from the frame for an open truck bed. Bennett does not disclose an equally simple methodology to remove the frame should the vehicle operator also prefer a completely open truck bed.

A problem specific to the second method of installation, in which a plurality of clamps are used to engage the frame assembly of the hard cover to the truck bed, is that the clamps become loose during normal vehicle operation. This problem may result from vehicle vibration during normal driving conditions or vehicle flexing during off-road travel. In both events, when the clamps loosen, a number of dangerous conditions can result. Therefore, in order to prevent loose clamps from creating dangerous conditions, it is necessary for the vehicle operator to carry a hand tool that is periodically used to retighten the clamps after a period of driving, or before a road-trip. Although this is an acceptable solution to a problem, regrettably, not all vehicle operators are as pre-cautious as they should be when using a fiberglasshard cover with tool operated clamp-on hardware. All of the prior art referenced by the applicant discloses clamps or fasteners that require the use of hand tools or the like. A clamp body using a tool operated threaded fastener similar to the one disclosed in the present embodiment is referenced in U.S. Pat. No. 5,860,691 to Thomsen et al. Another clamp arrangement, which is disclosed in U.S. Pat. No. 5,904,393 to Yoder, could be adapted to receive a hand-operated fastener for the advantage of inspection and re-tightening. Clamps having a cam action that do not require hand tools are proposed by Love in U.S. Pat. No. 5,765,902 and Rippberger in U.S. Pat. No. 5,975,618. The problem with these clamps is that they are developed to interface with largely proprietary rail extrusions. Therefore, these concepts are not immediately useful for wide scale implementation. Fiberglass onneau cover manufactures have not learned and do not know that a lightweight hard cover can use hand-operated clamps with success.

What is needed is a “no-drill” and a “no-tool” method of attaching a hard cover to a pickup truck bed. The “no-drill” and “no-tool” method should also be easy to use and convenient to allow the vehicle operator to use an open truck bed and to return to a closed truck bed when desired, The present invention fulfills these needs by successfully adapting the four elementary mechanical systems of tonneau covers to a thermoformed hard cover. The present invention also teaches that a thermoformed hard cover can be disengaged from a rail assembly to simplify removal and reinstallation of a hard cover. Finally, the present invention provides means for the vehicle operator to inspect and ensure installation equipment is secure and properly engaged for safe driving.

### SUMMARY OF THE INVENTION

It is a primary object of the present invention to provide a lightweight thermoformed hard cover assembly for the bed of a pickup truck vehicle. The present invention comprises a thermoformed hard cover and a thermoformed rail assembly. According to this aspect, the thermoformed rail assembly engages the truck bed, and the thermoformed hard cover engages the rail assembly of operative use.

It is an object to provide a thermoformed hard cover that is hinged. According to this aspect, the hinge of the thermoformed hard cover is adapted to distribute hinge stress over a comparably wide area.

It is another object to provide a thermoformed hard cover with a lock. According to this aspect, the thermoformed hard cover encapsulates locking apparatus that engages a lock-receiving end that accommodates the thermal movement of a thermoformed hard cover.

It is another object to provide a thermoformed hard cover with a lift system. According to this aspect, the thermoformed hard cover uses a lift system arranged to produce a constant closing force when the thermoformed hard cover is closed. According to yet another aspect, forces of the lift system are deflected over a comparably wide area of the thermoformed hard cover.

It is another object to provide a frame support for the thermoformed hard cover. According to this aspect, a decorative thermoformed rail cover is provided with the frame support. According to this aspect, the thermoformed rail cover offers protection for the truck bed. According to yet another aspect, the thermoformed rail cover is adapted to channel unwanted matter away from the interior of the truck bed. The thermoformed rail cover is adapted to conceal rigid frame support members.

It is yet another object to provide a thermoformed hard cover assembly that is removable. According to this aspect, the comparatively lightweight thermoformed hard cover is removed from the rail assembly to provide an open truck bed. According to another aspect, the rail assembly can remain in place or be removed altogether. According to these features, the thermoformed hard cover is removed while the decorative rail assembly remains in place for simplified reinstallation.

Still according to this object, a detachable hinge element is used to interface between the thermoformed hard cover and the rail assembly. The hinge apparatus uses hand-operated knobs to engage the hinge bracket in the operative conditions for opening and closing of the hard cover relative to the truck bed.

Still according to this object, the rail assembly is engaged to the truck bed by hand operated clamps for a “no-tool” installation. Hand operated clamps can be used in substitution of tool operated clamps to disengage the rail assembly from the vehicle when a completely open truck bed is required. According to these features of the present invention, a “no-drill”, “no tool”method of installation is proposed.

According to another aspect of the present invention, hand operated clamps simplify the task of periodically inspecting and re-tightening clamps that become loose due to vehicle vibration and flexing.

It is another object to provide a hard cover that prevents the unwanted opening and closing of the truck bed tailgate. According to this aspect, a thermoformed member of the rail assembly is affixed to the thermoformed hard cover.

It is another object to provide a rail assembly that accommodates the thermal movement of the thermoformed hard cover. According to this aspect, the thermoformed rail cover is adapted to receive a moving thermoformed hard cover.

Briefly, in accordance with this invention, there is provided a hard cover assembly that is easy to install and inspect for safe operation. The hard cover assembly combines a unitary thermoformed hard cover with an attractive rail assembly that is separately engaged to the pickup truck bed by means of hand operated clamps, for a no drill, no tool installation.

Other objects, aspects, features and advantages of the present embodiment of the invention will become apparent from the following descriptions and appended claims when taken in conjunction with the accompanying drawings.

### DESCRIPTION OF THE DRAWINGS

FIG. 1 is a perspective view of the hard cover in an open position upon a pickup truck bed.

FIG. 2 is a perspective section view showing the inside structure of the hard cover in the area of the tailgate.

FIG. 3 is a partial perspective view showing the prop components of the hard cover assembly.

FIG. 4 is an exploded perspective showing the passenger side rail member of the rail kit.

FIG. 5 is a sectional view showing the relationship of the hard cover perimeter lip to the channel of the rail kit.

FIG. 6 is a perspective view showing how the driver side rail is positioned on the bed rail.

FIG. 7 is a perspective view showing the rail kit positioned upon the bed rail.

FIG. 8 is a perspective sectional view suggesting how the rail kit is clamped onto the bed rail.

FIG. 9 is a perspective view showing how the hinge bar interfaces with the rail kit.

FIG. 10 is a perspective view pointing out certain features of the hard cover assembly.

FIG. 11 is a side section suggesting how the hinge bar engages the rail kit and fastened to the hard cover with hand knobs.

### DETAILED DESCRIPTION OF THE PREFERRED EMBODIMENTS

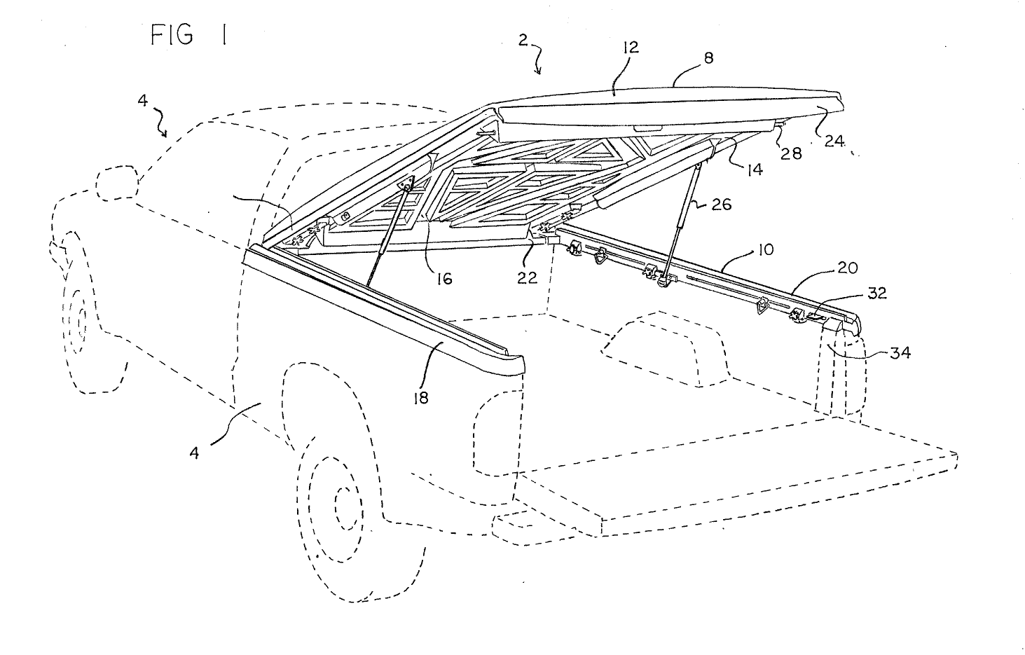

According to the present invention disclosed in FIG. 1, a hard cover assembly 2 is seen installed upon the truck bed 4 of a pickup truck vehicle 6, here shown in phantom. The hard cover assembly 2 comprises a unitary hard cover 8 and a protective rail assembly 10.

The hard cover 8, in the present embodiment, is constructed out of two sheets of heat deformable thermoplastic material. The top sheet 12, in the present arrangement, is a coextruded construction comprising a suitable weatherable thermoplastic material, such as Bayer Corporation's Centrex® 485 ASA/AES sheet extrusion grade polymer, and an ABS polymer substrate. In the present example, the Centrex® material is provided with a textured surface, such as a fat line hair cell texture, to provide a scratch resistance finish. The bottom sheet 14 is extruded out of a preferably low impact ABS polymer that provides a more rigid construction. The top sheet 12 and bottom sheet 14 are selectively fused together by known means in areas 16 where the two thermoformed sheets achieve interfacial contact. In other embodiments, hard cover 8 may be made from other heat deformable thermoplastic materials such as polyethylene, or from thermosetting resin materials, including fiberglass, of known nature. The present twin sheet construction of the hard cover 8 may also be modified with the addition of a foam core operable to rigidify a thermoformed hard cover.

The protective rail assembly 10, in the present embodiment, comprises four members including a driver side member 18, a passenger side member 20, a front wall member 22, and a tailgate member 24. The four members unite to provide protective rail assembly 10. The four members 18, 20, 22 and 24 are preferably constructed out of the same material as the top sheet 12, so that the hard cover assembly 2 blends together and has an attractive finish and appearance in different operative conditions.

As seen in FIG. 1, the hard cover 8 is supported in an open position by opposing props 26. As may be understood by referring to the latch rods 28, cover 8 is locked in a closed position by actuating a handle 30 that thrusts the latch rods 28 outward to engage rod brackets 32 attached to the members 18 and 20 in the areas near the tailgate pillars 34. The hard cover 8 is hingedly engaged by elements of the members 18 and 20, hidden from view in the present figure adjacent the front wall member 22. Accordingly, it may be appreciated that hard cover 8 opens and closes to provide the vehicle operator with access to cargo stored within the truck bed 4.

It should also be understood, in reference to the present embodiment, that hard cover 8 is of a size that is substantially common to a number of different truck bed makes and models. Accordingly, the one hard cover 8 represented in FIG. 1 will fit a number of different pickup truck makes and models in a similar standardized bed length which have been fitted with a specific make and model dedicated rail assembly 10. A handful of hard covers 8 are therefore developed to fit the full range of pickup truck models offered. It should also be understood that the protective rail assembly 10 is provided to adapt the hard cover assembly 2 to a specific make and model of pickup truck. A handful of protective rail assemblies 10 are therefore adapted to cooperate with one hard cover 8 to provide a closely fitting truck specific hard cover assembly 2.

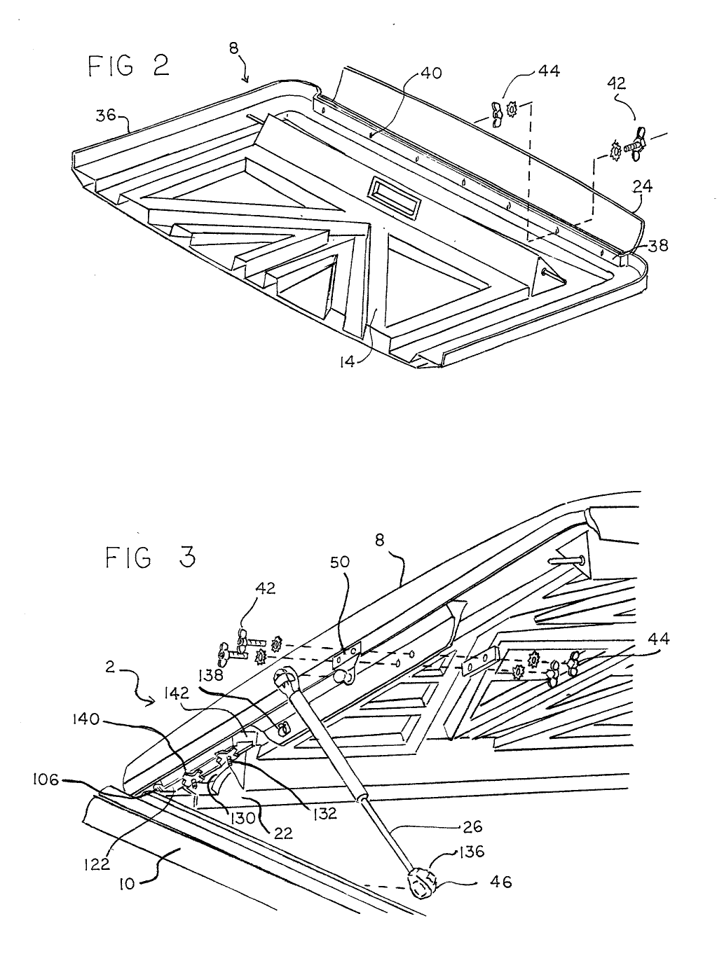

Turning now to FIG. 2, the rear section 36 of hard cover 8 is seen. In this figure the method for attaching the tailgate member 24 to the back wall 38 of the hard cover 8 may be understood. In the present embodiment, a plurality of predrilled holes 40 are included in the both the tailgate member 24 and back wall 38. The holes 40 align when the member 24 and wail 38 are brought together for assembly. Tailgate member 24 is attached to wall 38 by threading thumbscrews 42 through thumbnuts 44 in the manner suggested. This methodology is used so that assembly of the vehicle specific tailgate member 24 to a common size hard cover 8 can be accomplished without the need for hand tools. Other fastening or adhering means may be employed in keeping with the objective of providing a no-tool assembly and installation.

It may also be appreciated that the present arrangement prevents the tailgate of the vehicle from being opened when the hard cover 8 is closed. The tailgate member 24 extends downward from the perimeter margin defining the hard cover 8, overlaying the tailgate when in a closed position. This arrangement is also preferred in the present embodiment because a tailgate member 24 that mounts upon the top ledge of the tail gate is subjected is damaging cargo handling operations and load bearing conditions. The tailgate member 24 is mounted to the cover 8 so that it is removed from potential damaging conditions when the cover 8 is opened.

Referring now to FIG. 3, the method for attaching the props 26 to the hard cover assembly 2 may be understood. The props 26 have ball socket ends 46 that engage ball studs 48 supported upon stud brackets 50. The props 26 attach to the stud brackets 50 that are in turn attached to the hard cover assembly 2 in the manner suggested. Other fastening means may be employed in keeping with the objective of providing a no-tool assembly and installation. In the most preferred method, a threaded aluminum bar 43 is contained within the molded prop support in 41 of the bottom sheet 14. The threaded aluminum bar 43 receives a threaded stud 47 engaging prop 26. The bar 43 provides the further benefit of providing deflective strength to the prop support 41. It may also be convenient to use a clip 138 to retain the free end of the prop 26 when it is disengaged from the rail assembly 10 during times when the hard cover 8 is removed for an open truck bed.

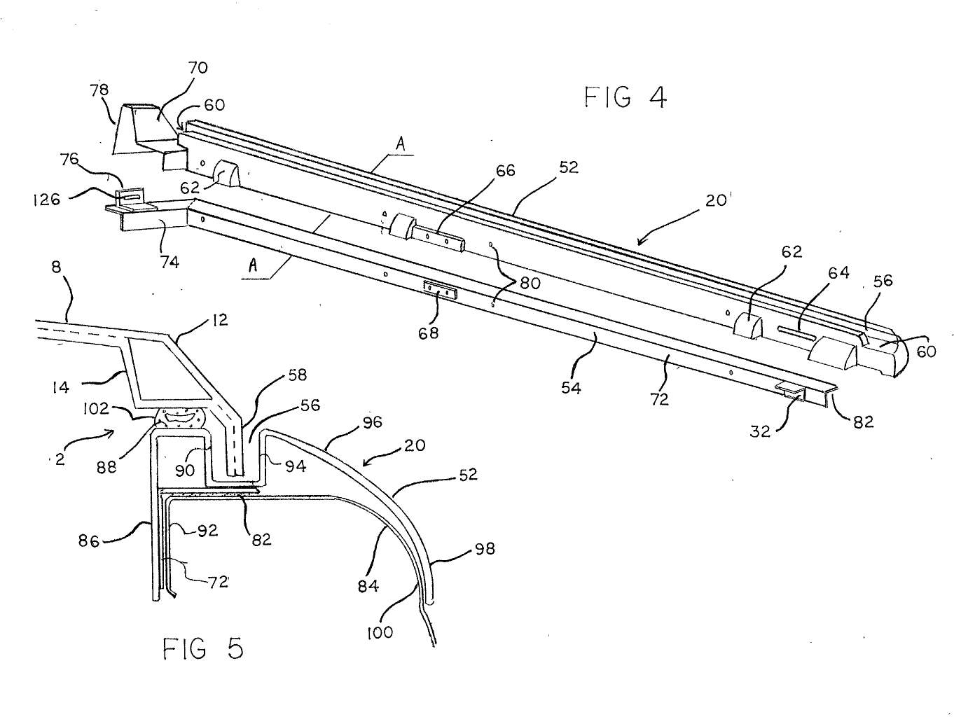

Turning now to FIG. 4, a closer look at the construction of and passenger side member 20 is provided, it being understood driver side member 18 is a mirror image of said passenger side member. Member 20 includes a molded plastic rail protector 52 and a rigid frame structure 54. In the present embodiment, rail protector 52 includes a channel 56 that receives the down turning lip 58 of hard cover 8 when closed. Channel 56 also acts as a rain gutter to channel water away from the inside of the truck bed 4. The channel 56 is open toward the front and rear 60 of the vehicle to enable the run-off of water. The molded rail protector 52 also includes a plurality of clamp positioning pockets 62, a slot 64 to receive a lock bracket 32, a fixed prop bracket emboss 66 to accommodate a prop bracket block 68, and an elevated pocket 70 to receive the opposed ends of the front wall member 22.

The rigid frame structure 54 is provided to give the molded plastic rail protector 52 strength and longitudinal stability. The structure 54 is composed of a long angle piece 72, upon which a rod bracket 32 and a prop bracket block 68 are welded. The structure 54 also includes a short angle piece 74, which is welded to long piece 72 at a substantially right angle in a position adjacent the truck bed front wall. The short angle piece 74 also includes a hinge bracket 76 having a slot 126. The portion of the short angle piece 74 with the hinge bracket 76 extends beyond the margin 78 formed by the pocket detail 70 of the plastic rail protector 52. The rail protector 52 is attached to the aluminum structure 54 in an overlying relationship to provide a unitary construction by means of a plurality of mechanical fasteners in the areas referenced by holes 80. The top inside surface of structure 54 receives a foam strip 82 including single sided tape. The foam tape 82 prevents the structure 54 from damaging the painted surfaces of the bed rails 84. The driver side member 18 and passenger side member 20 are positioned onto the truck bed 4, and the (aluminum) rigid frame structure 54 communicates directly with the truck bed rails 84.

In reference to lock bracket 32, it is desirable to provide a lock receiving end that accommodates the movement of a lock end, which movement is due to the relative expansion and contraction of a central body portion of the thermoformed hard cover. In the embodiment disclosed the brackets 32 engage the rod ends 28 of the lock apparatus when the hard cover 8 is closed. The brackets 32 extend laterally front to back a distance greater than the combined thickness of the rod ends, plus the range of movement characteristic of the hard cover 8 in extreme temperature operating environments. In the present case, the bracket is at least one inch wide, but preferably two inches, to capture the rod ends 28 in a wide range of temperature environments.

FIG. 5 provides a cross-section view of pre-assembled passenger side member 20, taken along lines A-A of FIG. 4, upon the bed rail 84 of truck bed 4. Plastic rail protector 52 includes an inside lip 86 that extends downward from a compression ledge 88 formed on the inside margin 90 of the channel 56. The length of lip 86 exceeds the length of the down turn lip 92 of the bed rail 84. The outside margin 94 of channel 56 joins exterior rail portion 96, which is molded at its lower margin 98 to closely conform to the outside contours 100 of the bed rails 84. In this manner, the plastic rail protector 52 has the appearance of being an integral part of the truck bed 4. As may also be appreciated in reference to the present figure, hard cover 8 includes a down turned lip 58 that is received by channel 56 when the hard cover 8 is closed. When in the closed position, gasket 102, adhering to bottom plastic sheet 14, compresses against compression ledge 88 to produce a water resistance seal. As may also be seen, the distance between the inside margin 90 and the outside margin 94 of channel 56 is greater than the width, in cross-section, of the lip portion 58 of hard cover 8. This arrangement is preferred because the thermoplastic materials used to construct the hard cover 8 expand and contract in response to elevated and low temperature conditions, respectively. Accordingly, channel 56 is equal in width to the thermal movement associated with the operating environments to which the hard cover 8 will be exposed. Therefore, the present figure suggests where the downturn lip 58 of hard cover 8 is positioned within the channel 56 when the medium operating temperature is 60° F. It may also be appreciated that the outside margin 94 of channel 56 may be brought closer to the down turn lip 58, so that under elevated temperature conditions, the lip 58 expands to the outside margin 94. When this occurs, additional expansion of hard cover 8 is accommodated by the side-to-side upward deflection of the central body portion of the hard cover 8. In this arrangement, the hard cover 8 will appear to move in a “crowning” action when the operating temperature reaches elevated extremes.

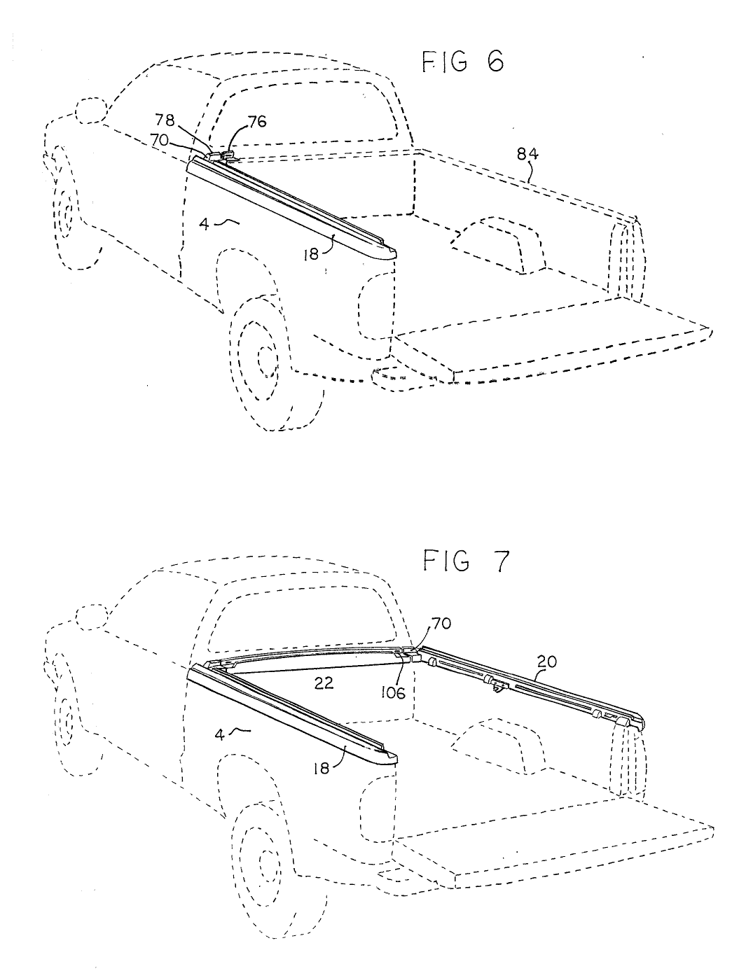

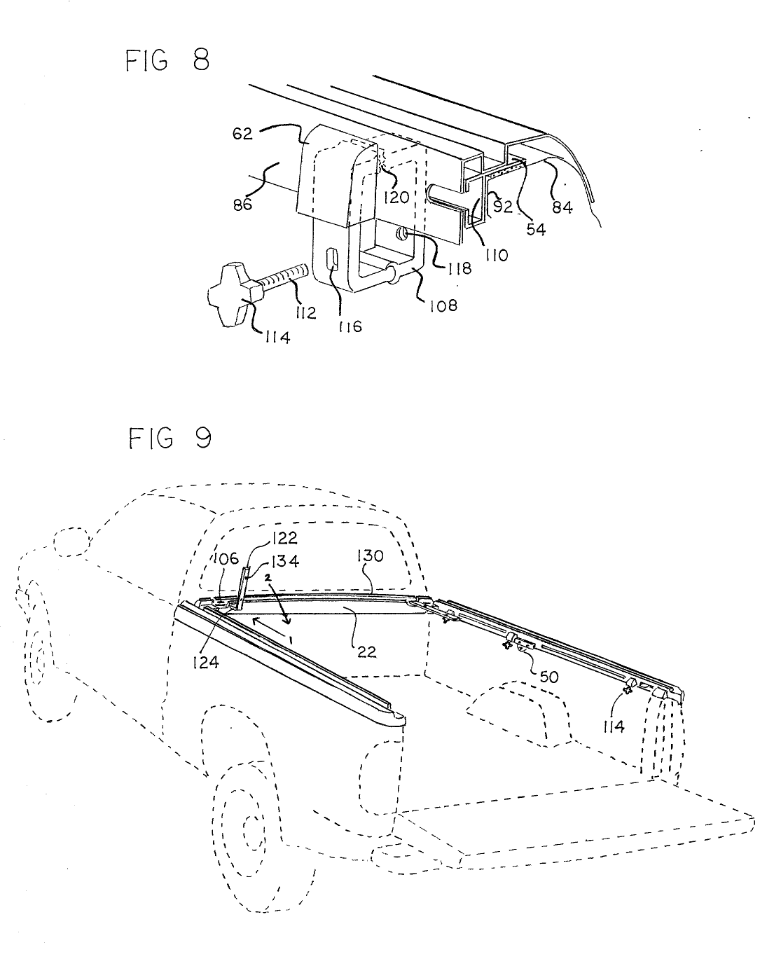

Turning now to FIGS. 6, 7, 8 and 9, the manner in which the protective rail assembly 10 and hard cover 8 are installed without hand tools is suggested. As seen in FIG. 6, driver side member 18 is positioned upon the driver side of the truck bed 4. In this figure, the relative position of the hinge bracket 76 is seen extending beyond the margin 78 of the pocket 70. It would also be feasible to capture the hinge bracket 76 within an elongated pocket 70 so that the hinge bracket 76 does not extend beyond the margin 78. In FIG. 7, the driver side member 18 and passenger side member 20 are positioned on the truck bed 4 along with the front wall member 22. The front wall member 22 includes opposes ends 104, which insert into the pockets 70 formed in the plastic rail protectors 52. As suggested in FIG. 7, pockets 70 receive ends 104 of front wall member 20 in an overlaying arrangement so that only a small seam between the members 18 and 20, and 22 is visibly apparent. Also seen in FIG. 7 are two slots 106 formed in front wall member 22. Slots 106 are used in the hinge arrangement that will be discussed below. After the members 18, 20 and 22 are positioned upon the truck bed rails 84, a plurality of hand clamps 108 are provided to secure the members 18 and 20 to the truck bed 4. As suggested in FIG. 8, clamps 108 are positioned in the clamp positioning pockets 62 formed along the wall 86 of the plastic rail protector 52. The clamps 108 engage the downturn lip 110 of rigid frame structure 54 and inside lip 92 of bed rail 84. Engagement is achieved by inserting the thread portion 112 of hand knob 114 through the slotted hole 116 to the threaded hole 118 of the clamp 108 and turning the hand knob 114 to full tension. It should also be stated lock washers are used between the knob 114 and the clamp 108 to maintain tension. When full tension is achieved, the claw teeth 120 of the clamp 108 compress the lip 110 of the rigid frame structure 54 against the lip 92 of the bed rail 84. A plurality of hand clamps 108 are used to fasten the members 18 and 20 to the truck bed 4 for a no tool installation.

As will be understood by referring to FIG. 8, the installation of the rail kit 10 to the truck bed 4 is achieved without the use of hand tools. As may also be appreciated, the vehicle operator can periodically inspect the tension of hand knobs 114 to ensure that clamps 108 are properly engaged, and so that the hard cover assembly 2 is properly installed and secured for safe driving and access to the cargo stored within the truck bed 4. Other arrangements may be used in keeping with the objectives of providing a no-tool installation and a simple and convenient way of inspecting and re-tightening the installation hardware for safe operation.

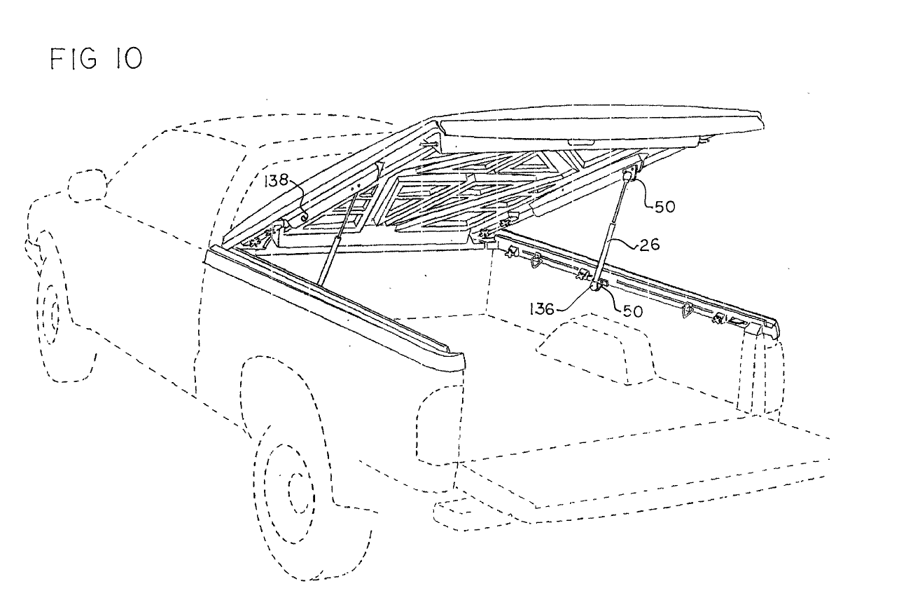

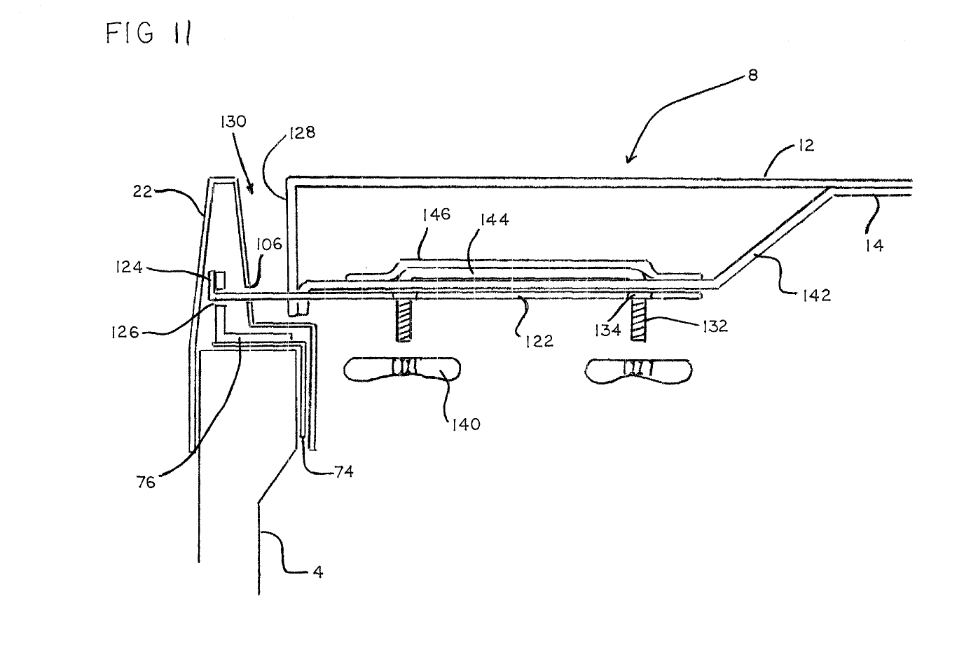

Turning now to FIGS. 9 and 10, the manner in which the hard cover 8 is installed onto the protective rail assembly 10 is suggested. After the clamps 108 have secured the members 18 and 20 to the truck bed 4, the hard cover 8 can next be installed. The first step is to insert two hinge bars 122 into the slots 106 provided on the front wall member 22. A short bend portion 124 of hinge bar 122 is inserted through slot 106 and corresponding slot 126 of hinge bracket 76. As suggested in FIG. 9 at the passenger side, after portion 124 is properly inserted, hinge bar 122 is pivoted into a lowered position so that the short bend portion 124 is engaged by slot 126.

Next, as shown in FIG. 10, the hard cover 8 is lifted over the truck bed 4 and a front wall 128 of the hard cover 8 is positioned within a channel 130 formed in the front wall member 22. While the hard cover 8 is manually maintained in an open position as suggested, the hinge bars 122 are manipulated by hand to insert threaded studs 132 projecting from the hard cover 8 through corresponding holes 134 on the extended portion of the hinge bars 122. After the hinge bars 122 are loosely engaged by the studs 132, the fixed ends 136 of props 26 are disengaged from the retaining clips 138 and rotated downward to so that the socket ends 46 of the props 26 can be installed onto the prop brackets 50 attached to the rail members 18 and 20. After the props 26 are in place, and the hard cover 8 is retained in the open position, pass-through hand knobs 140 are threaded over studs 132. A plurality of hand knobs 140 are thus rotated to full tension to compress the hinge bars 122 into a fixed position against a platform provided to receive the hinge bars. FIG. 3 may also be referred to, to better appreciate the details of this arrangement. As can be seen in this view, the hinge bars 122 reside in a platform 142 molded into bottom sheet 14, that is adapted to deflect the forces of strain associated with the hinging action upon the hard cover 8. The platform 142 is further adapted to support the studs 132 of the hinge apparatus. In the present embodiment, a reinforcing plate 146 is welded to the interior surface of the platform 142 preventing interior segments of the threaded stud 132 from movement. Reinforcing plate 146 also strengthens the platform to help prevent deflection upon the rigid cover in a region adjacent the front wall 128. It should be further explained that the studs 132 are segments of a u-bolt 144 that is contained within the platform 142 formed by bottom sheet 14. U-bolt 144 is preferred so that studs 132 will not loosen with wear-and-tear and rotate as hand knobs 140 are employed to secure hinge bar 122 to hard cover 8. This arrangement may be better appreciated in FIG. 11.

It may also be suggested that the u-bolt 144 arrangement of FIG. 11 may be substituted with two captive threaded inserts (not shown) and the pass through hand knobs 140. The threaded segments 132 of the u-bolt may be substituted with hand knobs 114 having thread portions 112.

Thus, it may be appreciated that the hard cover 8 may be attached to the protective rail assembly 10 by means that do not require hand tools. Furthermore, when the vehicle operator wishes to remove the hard cover 8 for an open truck bed, the reverse procedure is used to remove the hard cover 8. The hard cover 8 can therefore be disengaged from the rail assembly 10, which may optionally remain installed on the truck bed while the hard cover 8 is removed. In the present arrangement, the unsightly mechanical apparatus of the rail assembly 10 is concealed by the decorative molded plastic members 52 which provides an attractive appearance. When a completely open truck bed 4 is preferred, the entire hard cover assembly 2 can be conveniently removed without tools by detaching the clamps 108 and lifting the rail assembly 10 away from the bed rails. Other arrangements may be used in keeping with the objectives of providing a no-tool installation and a simple and convenient way of inspecting and re-tightening the installation hardware for safe operation.

Briefly, in accordance with this invention, a hard cover assembly is provided for installation onto the bed rails of a pickup truck. A rigid cover is combined with a rail assembly to provide a complete assembly. The rail assembly mounts directly to the bed rails with a series of hand clamps, and the rigid cover mounts to the rail kit with a series of hand knobs. The hard cover and rail kit are separately or both removable from the bed rails to provide an open truck bed. Hand clamps and knobs are provided for a “no-drill” and a “no-tool” installation. The hand fasteners can be inspected to insure the hard cover assembly is securely mounted to the truck bed for safe operation and driving. The hard cover and rail assembly is adapted to accommodate the thermal movement of the hard cover in both elevated and low temperature environments. It is to be understood that the drawings and descriptive matter herein are in all cases to be interpreted as merely illustrative of the principles, methods and apparatus of the invention, rather than as limiting in any way, since it is contemplated that various changes may be made in various elements to achieve like results without departing from the spirit of the invention or the scope of the appended claims.

1. A rigid cover assembly for a pickup truck with an open bed defined by a front wall and opposed side walls, the rigid cover assembly comprising:
A rigid cover having by a slightly crowned central body portion and a front depending margin, and adjacent the front depending margin at least one threaded stud;
A rail assembly composed of a front wall member, opposed side wall members and at least one slotted bracket, said members being developed to detachably rest upon said corresponding front wall and opposed side walls of said open bed, and said slotted bracket being juxtapositioned adjacent said threaded stud; and
A hinge bar comprising a short bend portion and an extended flat portion, the extended flat portion having at least one opening;
Wherein the short bend portion of the hinge bar is received by the slotted bracket of the rail assembly, the extended flat portion of the hinge bar receives the threaded stud of the rigid cover through the opening, the hinge bar thereby detachably joining said rigid cover to said rail assembly for relative movement of said rigid cover upon the open bed to the pickup truck.

2. A rigid cover assembly as in claim 1 wherein the at least one threaded stud is a segment of a U-bolt.

3. A rigid cover assembly as in claim 1 wherein said threaded stud is a segment of a U-bolt and there is least one U-bolt having two threaded stud segments adjacent the front depending margin of the rigid cover.

4. A rigid cover assembly as in claim 3 wherein the extended flat portion of the hinge bar includes two openings receiving two threaded stud segments of the U-bolt.

5. A rigid cover assembly as in claim 1 wherein the hinge bar is restrained from releasing the received threaded stud by means of a manually adjusted pass-through threaded hand knob.

6. A rigid cover assembly as in claim 1 wherein the rigid cover has a molded platform depending from an interior surface adjacent the front depending margin to receive the hinge bar, the molded platform comprising a shoulder defining a hinge bar recess, the recess restricting movement of the hinge bar, and sloping walls radiating outward from the shoulder to the interior surface to widely distribute stresses upon the slightly crowned central body portion of the rigid cover.

7. A rigid cover assembly as in claim 6 wherein the molded platform defines a hollow structure receiving a captive segment of the threaded stud, the hollow structure being reinforced with a plate, the plate restraining the captive segment from movement and providing extra strength to molded platform.

8. A locking apparatus for a rigid cover composed of a plastic material having a relatively high coefficient of linear thermal movement for a pickup truck with an open bed defined by a front wall, opposed side walls and a tailgate, the locking apparatus comprising:
An exteriorly visible central body having a rotating action, the central body receiving a key to selectively enable and disable the rotating action;
An interiorly visible cam linkage affixed to the central body, the interior cam linkage being selectively rotatable;
Two laterally extending members, the members being attached at first ends to the cam linkage and adjacent second ends thereof to holders restraining the second ends of the members in fixed position; and
Two striker plates with elongated member receiving elements, one striker plate being attached to each one of the opposed side walls of the open bed of the pickup truck nearby the tailgate, the two striker plates receiving and releasing the second ends of the two laterally extending members upon selective rotation of the central body in widely varying temperature environments.

9. A locking apparatus of claim 8 wherein the elongated member receiving element of the striker plate is adapted to receive the second end of the laterally extending member in temperature extremes ranging from −40° F. to +160° F.

10. A locking apparatus of claim 8 wherein the laterally extending member is a rod.

11. A locking apparatus of claim 8 wherein the cam linkage and the first ends of the laterally extending members are contained within a plastic housing depending from an interior surface of the rigid cover, the plastic housing including a removable panel providing access to said cam linkage for adjustment and repair.

12. A method for hand fastening a rigid cover upon a pickup truck with an open bed frame bordered by a front wall and opposed side walls, the method comprising the steps of:
Providing a rigid cover with at least two widely separated threaded studs adjacent a rigid cover front margin;
Providing a molded bed frame cover comprising a front rail segment, opposed side rail segments and at least two brackets adjacent the front wall, the molded bed frame cover concealing the open bed frame;
Providing a plurality of molded clamp positioning pockets upon the opposed side rail segments;
Providing a plurality of hand tightenable clamps;
Providing two hinge bars having a first bent end projectable through the bracket and a second flat end with an opening to receive the threaded stud;
Providing at least two hand knobs receiving the threaded studs;
Placing said molded bed frame cover upon the open bed frame;
Placing said hand tightenable clamps in the molded clamp positioning pockets;
Tightening said hand tightenable clamps to hand fasten the molded bed frame cover to the open bed frame;
Positioning said rigid cover upon the molded bed frame cover where the threaded studs aligned with the brackets adjacent the front wall;
Inserting the bent ends of the hinge bars through the brackets and the threaded studs through the openings of the flat ends of the hinge bars; and
Tightening said hand knobs upon the threaded studs engaging the hinge bars intermediate the rigid cover and the molded bed frame cover, the bent ends of the hinge bars engaging the brackets allowing the rigid cover to be moved into open and closed positions upon the truck bed.

13. The method of claim 12 further comprising the steps of routinely inspecting the hand tightenable clamps insuring the molded bed frame cover is securely hand fastened to the open bed frame for safe operation of the pickup truck.

14. The method of claim 12 further comprising the steps of routinely inspecting the hand knobs restraining the hinge bars to insure the rigid cover is securely hand fastened to the molded bed frame cover for safe operation of the pickup truck.

15. The method of claim 12 further comprising the steps of providing said plurality of hand tightenable clamps comprising a first clamp segment defining a “U” shape with claw teeth at a first end and a ball stud at a second end and a slotted opening intermediate the ends thereof, a second clamp segment defining a “U” shape with claw teeth at a first end and a ball socket at a second end and a threaded opening intermediate the ends thereof, and a plurality of hand knobs having a projecting threaded element the threaded element projecting through the slotted opening of the first clamp segment for receipt within the threaded opening of the second clamp segment, the hand knobs being hand tightenable to compress the claw teeth of the first and second clamp segments restraining the molded bed frame cover upon the open bed frame of the pickup truck.

16. The method of claim 12 wherein the opposed side rail segments of the molded bed rail cover are provided permanently affixed thereto rigid frame members, the rigid frame members comprising rigid segments adjacent the molded clamp positioning packets, the rigid segments being juxtapositioned adjacent the opposed side walls when said molded bed rail cover is positioned upon said open bed frame, the rigid segments being compressed against said opposed side walls when said hand tightenable clamps are tightened to hand fasten the molded bed rail cover to the open bed frame of the pickup truck.

17. The combination of a rigid cover and a molded rail kit for the open bed of a pickup truck, the combination comprising:
A rigid cover constructed out of a plastic material exhibiting a relatively high coefficient of linear thermal movement operating within an environment having a relatively wide temperature variation including a low temperature extreme and a high temperature extreme, the rigid cover being characterized by a central body portion and four depending walls terminating in a perimeter lip; and
A molded rail kit detachably mounted upon the open bed to cover a front bed rail and opposed side bed rails, the molded rail kit having a channel defined by an interior wall, an exterior wall and a traversing section there between, the channel receiving the perimeter lip of the rigid cover, and the traversing section being adapted in interior wall to exterior wall width to accommodate the linear thermal contraction of the central body portion of the rigid cover at said low temperature extreme and the linear thermal expansion of the central body portion of the rigid cover at said high temperature extreme.

18. The combination of claim 17, wherein the channel of the molded rail kit is adapted to accommodate the perimeter lip of the rigid cover as a result of the linear thermal movement of the central body portion between the temperature extremes of −40° F. to +160° F.

19. The combination of claim 17, wherein the perimeter lip of the rigid cover occupies a position substantially intermediate the interior wall and the exterior wall of said channel at a medium ambient temperature of 60° F.

20. The combination of claim 17, wherein the central body portion of the rigid cover has a slightly crowned exterior surface and the perimeter lip is received by a channel comprising an interior wall, a transverse section and an exterior wall, the exterior wall occupying a position adjacent the perimeter lip limiting the linear thermal displacement of the perimeter lip within the channel and causing the slightly crowned exterior surface of the central body portion to expand upward in response to elevated temperature extremes.

21. The combination of claim 17, further comprising:
A rigid cover with a lock mechanism having actuating means generally positioned in the central body portion nearby a tailgate of the truck bed and latching means projecting beyond the perimeter lip;
A molded rail kit with an elongated bracket operable to engage the latching means when said actuating means urges said latching means into a locked position;
Wherein said elongated bracket of said molded rail kit is adapted to receive said latching means as said linear thermal movement of said rigid cover occurs during wide temperature variation.

22. The combination of claim 17, further comprising:
A lock mechanism including a lockable pop-up T-handle, a cam, and two rods projecting to opposed side wall margins adjacent the perimeter lip of the rigid cover;
An elongated rod bracket affixed to the molded rail kit comprising a horizontal flat portion extending laterally a distance greater than the range of lateral movement of said rods associated with said linear thermal movement of rigid cover;
Wherein rod ends are urged below said horizontal flat portion when said T-handle is actuated to prevent said cover from moving from a closed position to an open position upon said pickup truck.
